(19) United States
(12) Patent Application Publication
(10) Pub. No.: US 2008/0244380 A1
(43) Pub. Date: Oct. 2, 2008

(54) METHOD AND DEVICE FOR EVALUATING AN EXPRESSION ON ELEMENTS OF A STRUCTURED DOCUMENT

(75) Inventor: Herve Ruellan, RENNES (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 12/055,959

(22) Filed: Mar. 26, 2008

(30) Foreign Application Priority Data
Mar. 27, 2007 (FR) 0754071
Mar. 27, 2007 (FR) 0754072

(51) Int. Cl. G06F 17/00

(52) U.S. Cl. 715/234

(57) ABSTRACT

The invention concerns a method of evaluating an expression on items of a structured document, an expression comprising a set of elementary sub-expressions, that comprises the following prior steps: generating, from the expression, all the target nodes (920) corresponding to items to be sought in the structured document; generating a logical representation (930) of the expression, a logical representation comprising a set of nodes, representing the elementary sub-expressions of the expression, linked according to the relationships between these elementary sub-expressions; a step of evaluating the expression on items of the structured document from all the target nodes generated and the logical representation generated.

### TECHNICAL FIELD

The present invention relates to a method and device for evaluating an expression, in particular an expression of the XPath type, on elements of a structured document. It finds a general application in the processing of XML data streams and more precisely on files of the XML format.

### BACKGROUND OF THE INVENTION

The XML markup language, the acronym for “eXtensible Markup Language”, that is to say an extensible markup language, is a syntax for defining computer languages. This language is standardized by the W3C standardization committee (a description of the language can be found at the address http://www.w3.org/TR/REC-xml). The XML language is a syntax for defining new languages. Thus it is made possible to define a plurality of XML languages that can be processed using generic tools.

The XML language defines a particular syntax for mixing structural information and content information. The XML language defines several types of item for describing structural information and content information. According to this syntax, each element is defined by an opening tag comprising the name of the element (for example: <tag>), a closing tag also comprising the name of the element (for example: </tag>). Each element can contain other elements or textual data.

An element can also be specified by attributes. The attribute is an item located in the opening tag of an element and contains, apart from the actual content of the attribute, an identifier for defining it (for example: <attribute tag=“value”>).

XML syntax also makes it possible to define comments (for example: “<!--Comment-->”) and processing instructions, which can specify to a computer application which processing operations to apply to the XML document (for example: “<?my processing?>”).

All the objects described by XML syntax, namely the elements, attributes, textual data, comments and processing instructions, are grouped together under the designation “XML node”.

Finally, XML syntax is textual and can be read or written easily by a user.

Several different XML languages can contain elements with the same name. Thus, in order to be able to mix several different XML languages, XML syntax makes it possible to define namespaces (“Namespace” according to English terminology). In this way, two elements are identical if they have the same name and are situated in the same namespace.

A namespace is defined by a uniform resource identifier, also called URI, for example: “http://canon.crf.fr/xml/monlangage”.

The use of a namespace in an XML document is achieved by defining a prefix that is a shortcut to the uniform resource identifier of this namespace.

This prefix is defined by means of a specific attribute. For example, the expression “xmlns:ml=“http://canon.crf.fr/xml/monlangage” associates the prefix “ml” with the uniform resource identifier “http://canon.crf.fr/xml/monlangage”.

Next, the namespace of an element or attribute is specified by preceding the name with the prefix associated with the namespace followed by a colon “:” as illustrated in the following example: “<ml:tag ml:attribute=“value”>”.

The XPath language (the acronym for “XML Path Language”) comes from a specification of the W3C consortium called “XPath Specification 1.0”, present at the address www.w3.org/TR/xpath. The objective of this language is to find a syntax suitable for addressing parts of a structured document of the XML type.

This language was developed initially to provide a base common to various applications, for example to XSLT (the acronym for “extensible Stylesheet Language Transformations”) applications and XQuery, processing documents of the XML type.

The syntax of this language uses a syntax similar to that used in expressions relating to location paths in a file system, for example the expression relating to a location path “/library/book”.

The location paths, according to the syntax of the XPath language, define a set of XML nodes and the relationships between these nodes. For example, the path “/a/b” designates all the elements “b” that are children of a root element “a” of the XML document.

A location path thus consists of a set of location steps (“Steps”), each location step specifying a filiation, also called an axis according to XPath syntax (“AxisSpecifier”), a node test (“NodeTest”) and possibly a set of predicates (“Predicates”).

The filiation relationship makes it possible to define the relationship between the node selected by the location step and the contextual node or nodes. For the first location step, the contextual node is either the root of the document or the current node. For the other location steps, the contextual nodes are those selected by the previous location step.

By default, if the filiation relationship is not specified, the current location step concerns the direct children of the contextual nodes.

Other filiation relationships exist making it possible to navigate easily in the whole of the XML document.

For example, the path “/a/descendant::b” designates all the elements “b” descending, directly or not, from a root element “a” of the XML document.

Conversely, the path “b/ancestor::a” designates all the elements “a” that are ancestors (directly or not), of a child element “b” of the current node.

According to another example, the path “/descendant::a/following::b” designates all the elements “b” following an element “a” situated at any depth in the document.

A specific filiation relationship makes it possible to designate the attributes of an element. For example, the path “/a/attribute::b” returns the attribute “b” of the root element “a” of the XML document.

The filiation relationships comprise on the one hand the forward or descending filiation relationships (“forward axis”) that describe the relationships in the order of the document, that is to say relationships that will select nodes appearing in the document after the contextual node, and on the other hand the rearward or ascending filiation relationships (“reverse axis”), which describe relationships reverse to the order of the document, that is to say relationships that will select nodes appearing in the document before the contextual node.

The node test makes it possible to specify the characteristics of the nodes sought.

An example of a node test is the test on the name of the nodes to be sought.

For example, the expression “/descendant::a” returns all the elements “a” of the document.

According to another node test, it is permitted to obtain all the elements whatever their name.

For example, the expression “/descendant::*” returns all the elements of the document.

According to yet another node test, it is permitted to return the elements having a defined type.

For example, the expression “/descendant::comment( )” returns all the nodes of the document of the comment type.

The predicates make it possible to impose one or more additional conditions for seeking nodes that are solutions of a location step.

These conditions can take the form of a position.

For example, the expression “/a/b[2]” designates the second element “b” that is a child of the root element “a”.

They can also take the form of a test.

For example, the expression “/a/b[c]” designates all the elements “b” that are children of the root element “a” and having a child element “c”.

The conditions can also make it possible to verify the content of an element or of an attribute.

Thus, for example, the expression “/a/b[c=value]” designates all the elements “b” that are children of the root element “a” having a child element “c” whose textual value is “value”. In a similar manner, the expression “/a/b[@c=“value”]” designates all the elements “b” that are children of the root element “a” having an attribute “c” whose value is “value”.

A step of a location path can comprise several predicates. These predicates are applied successively to select the elements designated by the location step.

For example, the expression “/a/b[c][2]” designates the second element “b”, a child of the root element “a” and having a child element “c”.

In general, the order of the predicates is important.

Thus, for example, the expression “/a/b[2][c]” is different from the previous expression and designates the second element “b”, that is a child of the root element “a” and also verifies that this element has a child element “c”.

In addition to the location paths, XPath syntax describes a set of algebraic expressions and comparison expressions, making it possible in particular to express conditions in the predicates, as well as a set of functions making it possible for example to express predicates or process all the nodes designated by a location path.

In order to evaluate an XPath expression according to a first method, a location path is divided into a set of location steps and each step is processed successively.

For example, during the evaluation of the expression “/a/b[2]”, all the elements “a” that are root elements of the XML document are first sought and then, for each of these elements, all the child elements “b” are sought. Finally, from this set, the second element is selected. It should be noted that, if the XML document is correctly written, it comprises a single root element.

Such a method is described in the document US 2004060007 of Georg Gottlob, Christopher Koch and Reinhard Pichler. This method of evaluating an XPath expression is based on the decomposition of the expression into a set of elementary sub-expressions, and on the evaluation of each elementary sub-expression separately. The result of the evaluation of an elementary sub-expression is stored in a table called a context-value table, the context corresponding to the context of evaluation of the elementary sub-expression and the value corresponding to the result of the evaluation of the elementary sub-expression.

The results of the various elementary sub-expressions are then combined in order to generate a global result. Storing the results obtained makes it possible to avoid carrying out the calculation of the same expression a plurality of times in the same context and thus optimizes the calculation time for certain expressions.

According to a first application of this method, the evaluation begins with the evaluation of the elementary sub-expressions. Next, the results are combined in order to evaluate the complex expressions. The evaluation of each elementary sub-expression is stored in a context-table. According to this method, this table can be of very large size.

In addition, according to this method, numerous unnecessary intermediate results are calculated when the result is evaluated.

According to a second application of this method, the elementary sub-expressions are evaluated in an order corresponding to the semantics of the XPath expression.

Thus, when an elementary sub-expression is evaluated, all the evaluation contexts are known, in this way avoiding calculation of the unnecessary intermediate results.

A specific application of this method can be implemented by modifying a use of an XPath processor in order to avoid this processor evaluating the same elementary sub-expression several times for the same context. This modification consists of storing the result of each evaluation in a context-value table.

However, such a method has several drawbacks. This is because, according to this method, the whole of the document must be present in memory in order to evaluate an XPath expression. This is because, for appliances having limited memory capacities, for example for a video camera, this method does not make it possible to evaluate an XPath expression on a large XML document.

In the case of an appliance with small memory capacities, the processing of an XML document is in general carried out by means of a parser of the SAX type (“Simple API for XML” in English terminology).

The SAX-type parser is able to process sequentially the nodes of the XML document, that is to say the elements, the comments and the textual values.

However, the use of a SAX parser for evaluating an XPath expression does not make it possible to go back in the XML document. Consequently it is not possible to directly perform the evaluation of expressions comprising a rearward filiation relationship.

Nevertheless it is possible to construct methods making it possible to evaluate an XPath expression on an XML document by means of a parser of the SAX-type or equivalent.

Thus, according to a method known from the document US 2004068487 of Charles Barton, Phillipe Charles, Deepak Goyal and Mukund Raghavachari, an XPath expression is evaluated using a SAX parser.

To do this, a representation of the XPath expression comprising only forward relationships is created. In this way, it is no longer necessary to go back in the document.

However, according to this method, the evaluation can be carried out only on an XPath expression using a sub-part of the XPath language.

In particular, this method makes it possible to process only the predicates containing XPath paths. It therefore does not apply to position or value tests, to arithmetic expressions or to functions.

To perform the evaluation of an XPath expression, using a SAX type parser, several methods have been proposed.

More particularly, according to a first method described in the document US 2004206082 by Marcus Fontoura and Vanja Josifovsld of IBM, a SAX parser is used to resolve XQuery requests. As the XQuery language relies on the XPath syntax, it is thus possible to use that method to resolve XPath expressions by using a parser of SAX type.

However, this method does not enable all the combinations of predicates to be evaluated. In particular, it does not make it possible to resolve position predicates, nor predicates containing location paths with following or preceding type axis.

Furthermore, according to this method, the predicates are evaluated relative to an XML element at latest on occurrence of the closing tag of that element. Yet, in certain cases, the evaluation of the predicates relative to an XML element is not possible on occurrence of the closing tag of that element.

According to another method described in the document US 2004068487 by Charles Barton, Philippe Charles, Deepak Goyal and Mukund Raghavachar of IBM, in which an XPath expression is evaluated by using a SAX parser, the XPath expression is modified in such a way that it no longer includes forward relationships. Thus the problem of going back in the document is deleted.

However, such a method has several drawbacks. Thus, with this method only a subset of the XPath language can be evaluated. In particular, this method has the drawback of being adapted to process only predicates containing XPath location paths. This method therefore does not apply to position or value tests, to arithmetic expressions or to functions.

Having regard to the above, it would consequently be advantageous to be able to evaluate predicates in an expression, in particular an XPath expression, using a parser of the SAX type whatever the type and number of predicates while limiting the memory resources necessary and overcoming at least some of the drawbacks mentioned above.

### SUMMARY OF THE INVENTION

Having regard to the above, it would consequently be advantageous to be able to evaluate an expression, in particular XPath expressions, using a parser of the SAX type whatever the expression while limiting the memory resources necessary and dispensing with at least some of the drawbacks mentioned above.

According to a first aspect, the present invention aims to provide a method of evaluating an expression on items of a structured document, an expression comprising a set of elementary sub-expressions, that comprises the following prior steps:

generating, from the expression, a set of target nodes corresponding to items to be sought in the structured document.

generating a logical representation of the expression, a logical representation comprising a set of nodes, representing the elementary sub-expressions of the expression, connected according to the relationships between these elementary sub-expressions;

and a step of

evaluating the expression on items of the structured document using the set of target nodes generated and the logical representation generated.

The invention makes provision for finding, among the items of a structured document, the items responding to the evaluation of an expression, in particular of an XPath expression.

The items of a structured document are in particular described in a markup language structuring the data, for example using the XML language.

To allow this evaluation, the method according to the invention makes provision for generating on the one hand a set of target nodes corresponding to items to be sought and on the other hand a logical representation of the expression.

From the set of target nodes generated and the logical representation, the expression can be evaluated.

According to the invention, calculating numerous unnecessary intermediate results in the evaluation of the result is therefore avoided.

In addition, the evaluation of an expression is made possible on appliances having small memory capacities.

According to a particular embodiment, the step of generating a set of target nodes also comprises the generation of a representation of the relationships between the target nodes.

According to this characteristic, the target nodes are organized according to their relationships. This is because it may be useful to seek a second element only if a first element has been found.

According to a particular characteristic, the step of evaluating the expression comprises:

a step of filtering the items of the document using the set of target nodes; and

a step of evaluating the filtered items using the logical representation.

According to these characteristics, the items are filtered so as to keep only the events useful to the evaluation of the expression.

According to another particular characteristic, the step of filtering the items of the document using all the target nodes comprises a step of identifying the items of the document corresponding to target nodes from all the target nodes.

According to another particular characteristic, the step of evaluating the filtered items comprises a step of creating a solution node associated with a node of the logical representation, this solution node representing an evaluation result for the node of the logical representation.

According to one embodiment, the step of creating a solution node associated with a node of the logical representation, comprises a step of associating a filtered item with this solution node.

According to a particular characteristic, the step of evaluating the filtered items also comprises a step of creating a relationship between a first solution node associated with a first node of the logical representation and at least one second solution node associated with a second node of the logical representation in accordance with the relationship between the first node of the logical representation and the second node of the logical representation.

According to a particular characteristic, the step of evaluating the expression also comprises a step of verifying the completeness of a solution comprising the following sub-steps:

verifying the existence for each node of the logical representation of at least one associated solution node;

selecting for each node of the logical representation an associated solution node, all the solution nodes selected forming a solution;

for each relationship between two nodes of the logical representation, verifying that a similar relationship exists between the associated solution nodes selected.

According to one characteristic, the step of evaluating the expression comprises, if the step of verifying the completeness of a solution is positive, a step generating a result from the solution.

According to a particular characteristic, a search context is associated with a filtered item corresponding to a node of the logical representation and to a node of the logical representation that is a descendant of the node corresponding to the filtered item.

According to this characteristic, the search context makes it possible to determine whether the search for solutions for items has ended.

According to another particular characteristic, a search context comprises identification information for a part of the document in which an item corresponding to the descendant node is sought.

According to another particular characteristic, it comprises a step of transmitting a result as from the end of the evaluation of the expression.

According to one characteristic, the method comprises a step of eliminating a solution node, the elimination of a solution node being performed according to a validity criterion for the solution node.

According to another particular characteristic, the validity criterion for a solution node depends on the relationships existing between this solution node and other solution nodes and search contexts associated with the node of the logical representation associated with this solution node.

According to a second aspect, the invention relates to a device for evaluating an expression on items of a structured document, an expression comprising a set of elementary sub-expressions, that comprises:

means of generating, from the expression, a set of target nodes corresponding to items to be sought in the structured document;

means of generating a logical representation of the expression, a logical representation comprising a set of nodes, representing the elementary sub-expressions of the expression, linked according to the relationships between these elementary sub-expressions; and

means of evaluating the expression on items of the structured document from all the target nodes generated and the logical representation generated.

This device has the same advantages as the method briefly described above and will therefore not be repeated here.

According to a third aspect, the present invention concerns a method of evaluating a plurality of predicates associated with a sub-expression of an expression relating to items of a structured document, that comprises:

a step of associating at least one evaluation state with at least one predicate of said plurality of predicates,

a step of obtaining an event describing a part of the structured document,

a step of updating said at least one evaluation state on the basis of the obtained event, and

a step of evaluating the plurality of predicates on the basis of said at least one updated evaluation state.

The invention provides for evaluating predicates in an expression, in particular an XPath expression, for example by means of a SAX parser.

For this, at least one evaluation state is associated with the predicates, the evaluation state is updated on the basis of the event obtained describing a part of the document and it is evaluated if all the predicates are verified for the sub-expression.

In accordance with the invention, it is permitted to process multiple or nested predicates and this method is adapted to operate on light apparatuses.

According to a particular feature, the method comprises:

a step of creating at least one solution node representing at least one event describing a part of the structured document, and

a step of associating said at least one solution node with said sub-expression.

According to this feature, the solution nodes represent an event within a potential solution for the expression. Each solution node represents a value verifying an elementary part of the expression.

A potential solution groups together a set of solution nodes, complying with the logic of the expression.

More particularly, a step of associating at least one evaluation state associates an evaluation state with at least one pair comprising a predicate and a solution node.

According to one embodiment, the method comprises a step of deleting the solution node associated with the evaluation state if that evaluation state indicates that the predicate associated with that evaluation state is not verified and can no longer be verified.

According to this embodiment, it not being possible for the solution node to be a solution to the expression, the solution node is deleted.

Thus, the storage space taken by the potential results is reduced.

According to a particular feature, a predicate of the plurality of predicates being dependent on the position of the solution node, the position of the solution node is calculated as the position of the preceding solution node incremented by the value 1 if the position of the preceding solution node is known and if the predicates preceding said evaluated predicate are verified for the solution node.

According to another feature, the method comprises a step of updating at least one other evaluation state on the basis of said at least one updated evaluation state.

According to this feature, the interdependent predicates are updated. This is the case for example for the predicates concerning the position of an element.

According to one embodiment, said at least one evaluation state is stored in a table.

According to this embodiment, a table stores the evaluation state of each predicate for each of the candidate elements in order to permit the evaluation of predicates.

Thus, the updating of an evaluation state of a predicate may be carried out easily.

According to a feature, the method comprises a counting table comprising, for at least one predicate, the number of events verifying said at least one predicate.

According to a particular feature, the method comprises a step of transmitting a result if all the predicates are verified at the step of evaluating the plurality of predicates.

According to another particular feature, a predicate of the plurality of predicates being a location path, the evaluation state takes

a value indicating that the evaluation of the predicate is positive if the event obtained enables the updating step to complete the location path,

a value indicating that the evaluation of the predicate is negative if the event obtained enables the updating step to determine that a location path cannot be found, and

a value indicating that the evaluation of the predicate is indeterminate in the other cases.

According still to another particular feature, a predicate of the plurality of predicates being an expression, the evaluation state takes

a value corresponding to the result of the evaluation of the expression if the event obtained enables the updating step to complete the evaluation of the expression, and

a value indicating that the evaluation of the predicate is indeterminate in the other cases.

Thus, the evaluation state is particularly well-adapted to the predicates implemented by the processed expression.

According to a fourth aspect, the invention concerns a device for evaluating a plurality of predicates associated with a sub-expression of an expression relating to items of a structured document, that comprises:

means for associating at least one evaluation state with at least one predicate of said plurality of predicates,

means for obtaining an event describing a part of the structured document,

means for updating said at least one evaluation state on the basis of the obtained event, and

means for evaluating the plurality of predicates on the basis of said at least one updated evaluation state.

This device has the same advantages as the method briefly described above and they will therefore not be reviewed here.

The present invention also relates to an information storage means, possibly partially or totally removable, able to be read by a computer or a microprocessor storing instructions of a computer program, enabling the method as disclosed above to be implemented.

Finally, the present invention relates to a computer program product able to be loaded into a programmable apparatus, containing sequences of instructions for implementing the method as disclosed above, when this program is loaded into and executed by the programmable apparatus.

### BRIEF DESCRIPTION OF THE DRAWINGS

Other aspects and advantages of the present invention will emerge more clearly from a reading of the following description, this description being given solely by way of non-limiting example and made with reference to the accompanying drawings, in which:

FIG. 1 depicts an example of an XPath expression that is to be evaluated in accordance with the invention;

FIG. 2 illustrates all the target nodes generated by the invention from the XPath expression of FIG. 1;

FIG. 3 illustrates a logical representation of the XPath expression of FIG. 1 in accordance with the invention;

FIG. 4 illustrates an example of an XML document to which the XPath expression of FIG. 1 is applied;

FIG. 5 illustrates the solution nodes created after the processing of the event corresponding to the empty tag “a” referenced at 435 in FIG. 4;

FIG. 6 represents the context called “ctx-b” in FIG. 5;

FIG. 7 represents the context called “ctx-c” in FIG. 5;

FIG. 8 depicts a general flow diagram for evaluating an expression in accordance with the invention;

FIG. 9 depicts the various steps of processing an XPath expression in order to generate the target nodes and the logical representation corresponding to this expression in accordance with the invention.

FIG. 10 illustrates an algorithm for evaluating an XPath expression on an XML document in accordance with the invention;

FIG. 11 illustrates an algorithm for constructing the results from the events filtered by the targets in accordance with the invention;

FIG. 12 illustrates a hardware architecture on which the invention can be implemented;

FIG. 13 represents an example of an XPath expression that is to be evaluated in accordance with the invention;

FIG. 14 illustrates all the target nodes generated by the invention from the XPath expression of FIG. 13;

FIG. 15 illustrates a logical representation of the XPath expression of FIG. 13 in accordance with the invention;

FIG. 16 illustrates a table representing the evaluation state of the predicates in accordance with the invention;

FIG. 17 illustrates an example of an XML document to which the XPath expression of FIG. 1 is applied;

FIG. 18 illustrates a general flow diagram for evaluating predicates in accordance with the invention;

FIG. 19 represents an algorithm for creating a new node solution in accordance with the invention;

FIG. 20 represents an algorithm for deleting a node solution in accordance with the invention;

FIG. 21 represents an algorithm for updating the predicates evaluation table in accordance with the invention;

FIG. 22 illustrates an algorithm for verifying predicates for a node solution in accordance with the invention and

FIG. 23 illustrates an algorithm for verifying a predicate p for a node solution ns in accordance with the invention.

### DETAILED DESCRIPTION OF PREFERRED EMBODIMENTS

The invention consists of decomposing the evaluation of an expression, in particular of an XPath expression, in two parts. The first part consists of filtering the events received from the SAX parser so as to keep only the events useful to the evaluation of the expression. The filtered events represent a set of target nodes sought for the evaluation of the XPath expression. The second part consists of combining the filtered events in order to carry out the evaluation proper of the expression. This combination consists of creating potential solutions containing the state of evaluation of the various candidates able to be results of the XPath expression.

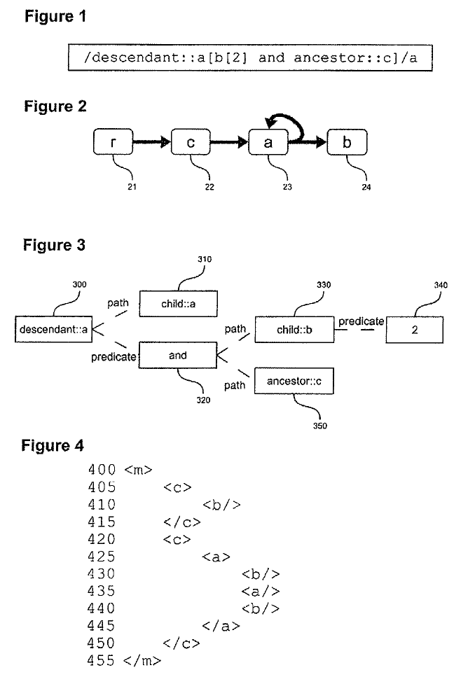

The expression 10 in FIG. 1 illustrates an example of an XPath expression able to be processed according to the invention.

According to this expression, elements “a” that are children of an element “a” situated at any depth in the document and having at least two direct children “b” and one ancestor “c” are sought.

FIG. 2 depicts all the target nodes generated in accordance with the invention from the XPath expression 10 of FIG. 1.

The target nodes of FIG. 2 correspond to the XML nodes sought for evaluating the XPath expression. The element “r” (target node 21) corresponds to the root of the XML document, and the element “c” (target node 22), the element “a” (target node 23) and the element “b” (target node 24) correspond to the nodes sought in the XML document by means of the XPath expression.

The target nodes are used to filter the events received by the entity able to perform the evaluation of an XPath expression on an XML document, also called an XPath processor (“XPath Processor” in English terminology). Thus the target nodes correspond to the node tests of the XPath expression. For each node test of the XPath expression, a target node is generated. However, if several identical target nodes are generated, they are grouped together in a single target node.

In accordance with the invention, a target node generated makes it possible to filter all the XML nodes corresponding to this target node. For example, according to the expression 10 in FIG. 1, a single target node is generated for all the elements “a”. This is because, the role of a target node being to filter the nodes of the XML document, a single target node suffices to perform this filtering.

In addition, in order to optimize the process of searching for the nodes, the target nodes are organized according to their relationships of order of appearance in the document as defined by the filiation relationships of the XPath expression.

In this way, according to the example illustrated in FIGS. 1 and 2, an element “b” is sought only after having found an element “a”.

In the same way, an element “a” is sought only after having found an element “c”.

These relationships of order of appearance are shown in FIG. 2 by arrows. The search process is optimized further by a precise description of the order of appearance relationships expressed in the XPath expression.

Thus, according to the example illustrated in FIGS. 1 and 2, a relationship between the target “c” and the target “a” is in particular a “difference in depth of at least one”.

Likewise, it is possible to describe precisely a filiation relationship of the following sibling node type (“following-sibling” according to the XPath expression) as a “child of the same element, with a higher order number”.

This precision in the description of the order of appearance relationships is at the origin of the arrow starting from the target node “a” and going back on itself. This is because, in this way, it is indicated that, after having found an element “a”, the search for a child element “a” of this first element “a” is pursued.

FIG. 3 illustrates a logical representation of the XPath expression 10 of FIG. 1 in accordance with the invention.

This logical representation makes it possible to evaluate the XPath expression from the nodes filtered by the target nodes generated as described in FIG. 2.

According to this logical representation, each elementary sub-expression of the XPath expression is represented by a logic node.

For example, the elementary sub-expression “descendant::a” is represented by a logic node “descendant::a”.

The links between the logic nodes describe their relationships within the XPath expression.

During the evaluation of an XPath expression, this logical representation also makes it possible to construct the solutions of the XPath expression.

For this purpose, a logic node receives the events filtered by the target nodes and uses them to construct solution nodes representing this event within a potential solution for the XPath expression. Each solution node represents a value verifying an elementary part of the XPath expression. The elementary part of the XPath expression verified by the solution node corresponds to the logic node associated with this solution node. A potential solution groups together a set of solution nodes, complying with the logic of the XPath expression. When a potential solution contains a solution node for each logic node of the XPath expression, this potential solution satisfies the whole of the XPath expression and therefore makes it possible to generate a solution for the XPath expression.

Thus, when an event “a” is received, it is detected by the target node “a” of FIG. 2 and transmitted to the two logic nodes “a” of FIG. 3, namely the “descendant::a” logic node 300 and the “child: a” logic node 310.

From the event “a”, the logic nodes 300 and 310 update the potential solutions of the XPath expression by creating one or more solution nodes representing this event “a”.

An example of an XML document to which the XPath expression 10 of FIG. 1 can be applied is now described with reference to FIG. 4.

According to this example, the result of the evaluation of the XPath expression 10 on the XML document of FIG. 4 is the second element “a” of this XML document.

When the XML document is processed by the SAX parser, events describing the XML document are transmitted to the XPath processor.

The actions of the XPath processor whose object is the evaluation of the XPath expression of the XML document described by these events are now described.

On reception of the event “Start of document”, this is received by the target node “r” 21. This target node creates a solution node “r” to represent this event. In addition, the target node “c” 22 is activated, with an activation context corresponding to the whole of the XML document.

Next, when the opening tag event “m” 400 is received, this is not received by any target and is therefore ignored.

The following event is the opening tag event “c” 405. This event is received by the target node “c”. The target node “a” is activated with an activation context corresponding to all the descendant nodes of this element “c”. In addition, a solution node “c1” is created to represent this event and is associated with the solution node “r” as a child of this node.

The XML document next comprises an empty tag “b” 410. The associated event is not received by any target node. This is because the target node “b” has not been activated.

Next the following event is the closing tag event “c” 415. This event is received by the target node “c”. This event marks the end of the activation context of the target node “a”. This target node is therefore deactivated.

In addition, the solution node “c1” is eliminated. This is because there is no element “a” of which the element “c” that it represents is the ancestor and, as the activation context of the target node “a” is terminated, it is no longer possible to find such an element “a”.

The following event is the opening tag event “c” 420. This event is received by the target node “c” and the target node “a” is activated with an activation context corresponding to all the descendant nodes of this element “c”.

In addition, a solution node “c2” is created and associated with the solution node “r” as a child of this node.

Next the following event is the opening tag event “a” 425. This event is received by the target node “a”. The target node “b” is activated with an activation context corresponding to all the child nodes of this element “a”. In addition, the activation context of the target node “a” is increased by all the child nodes of this element “a”.

The event “a” is transmitted to the two logic nodes “a” 300 and 310 of FIG. 3. The first logic node “a” 300 uses this event to create a solution node “a1”. In addition, a solution node “and1” is created as a child of the solution node “a1” and the solution node “c2” is associated with the solution node “and1” as a child of this node.

As the solution node “c2” forms a result for the location path that it constitutes, this result is transmitted to the solution node “and1”.

However, the solution node “and 1” having knowledge only of the value of only one of its operands, it cannot be evaluated.

The second logic node “a” 310 ignores this event, since it does not correspond to a child element “a” of another element “a” for which a solution node exists.

The following event is the empty tag event “b” 430. This event is received by the target node “b”. A solution node “b1” is created, a child of the solution node “and1”, to represent this element “b”. Another solution node “2-1” is created as a child of this node “b1”, representing the predicate “[2]” and corresponding to the logic node “2” 340.

Given that the predicate of the solution node “b” is evaluated falsely, these two newly created nodes, namely “b” and “2-1”, cannot participate in a solution of the XPath expression and are therefore eliminated.

The following event is the empty tag event “a” 435. This event is received by the target node “a” and the event “a” is transmitted to the two logic nodes “a” 300 and 310. The first logic node, the node 300 in FIG. 3, uses this event to create a solution node “a2”, with its child solution node “and2”. The solution node “c2” is associated with “and2” as a child of this node.

However, as the element “a” is empty and therefore cannot have a child sub-element “b”, these two solution nodes are immediately eliminated.

The second logic node “a”, namely the node 310 in FIG. 3, creates a solution node “a3” that is a child of the solution node “a1”. This solution node “a3” is a possible result for the XPath expression.

However, since not all the predicates of “a1” have yet been verified, the solution node “a3” cannot be returned as a result at this time in the evaluation.

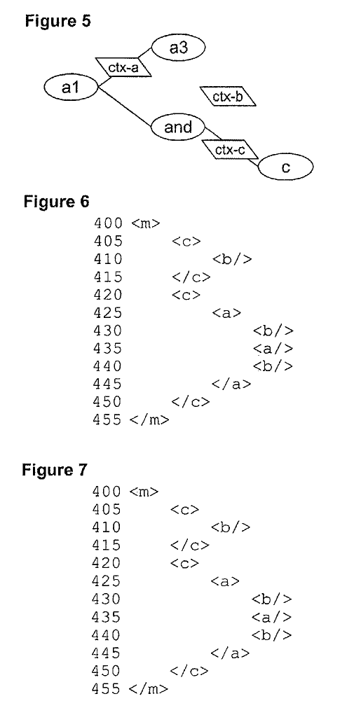

FIG. 5 depicts the solution nodes created after the processing of the event corresponding to the empty tag “a” 435.

It should be noted that, for each solution node created, the algorithm stores the search contexts of child solution nodes representing elements of the XML document.

FIG. 6 shows the context called “ctx-b” in FIG. 5 corresponding to the search context for solution nodes corresponding to child elements “b” of the element “a” present at reference 425 in FIG. 4. These are in fact elements enabling the predicate part “b[2]” of the XPath expression 10 in FIG. 1 to be verified.

FIG. 7 shows the context called “ctx-c” in FIG. 5 corresponding to the search context for solution nodes corresponding to ancestor elements “c” of the element “a” present at reference 425 in FIG. 4. These are in fact elements enabling the part of the predicate “ancestor::c” of the XPath expression 10 in FIG. 1 to be verified.

Returning to FIG. 4, the event following the event 435 is the empty tag event “b” 440. This event is received by the target node “b” and a solution node “b2” is created, a child of the solution node “and1”. Another solution node “2-2” is created as a child of this node “b2”.

Given that the predicate of the solution node “b2” is verified, a result is generated for the location path that it represents.

This result is transmitted to the solution node “and1”, which can be entirely evaluated as “true”. This evaluation result is transmitted to the solution node “a1”.

All the predicates of the path consisting of the solution nodes “a1” and “a3” being verified, the result represented by “a3” can now be returned.

In addition, the solution node “a3” is eliminated. This is because the result represented by this node has been retransmitted and it is therefore no longer necessary to keep it. Moreover, the solution nodes “and1” and “b2” are eliminated, the latter having been completely evaluated and no longer being able to serve for other evaluations.

On the other hand, the solution node “c2” is kept. This is because it can take part in any other solutions, in particular if there are other elements “a” in the remainder of the XML document.

All the following events are processed in the following manner, serving principally to eliminate the remaining solution nodes.

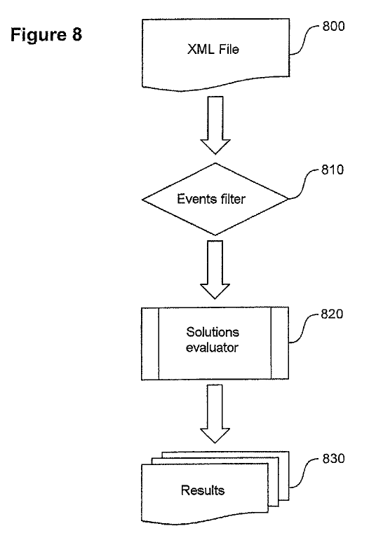

The general flow diagram for evaluating an expression in accordance with the invention is now described with reference to FIG. 8.

As described previously, an XML file 800 is processed by a SAX parser in order to generate events describing the data contained in the XML file.

These events are filtered by an event filter 810 from the target nodes generated from the XPath expression. The events that have passed the event filter 810 are then used by the solution evaluator 820 in order to create potential solutions to the XPath expression, in particular by means of the logical representation of the XPath expression.

Finally, the fully verified potential solutions generate results 830.

It should be noted that these various processes can be executed simultaneously. Thus, as soon as a potential solution is fully verified, the corresponding result can be generated immediately.

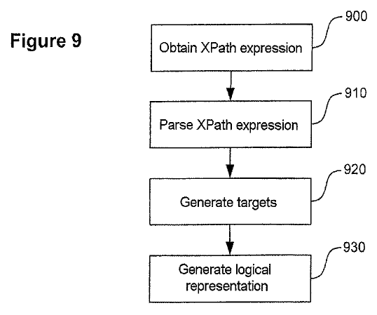

A description is now given, with reference to FIG. 9, of the various steps of processing an XPath expression in order to generate the target nodes and the logical representation corresponding to this expression.

The algorithm begins at step 900 with the obtaining of the XPath expression.

According to one embodiment, the XPath expression is obtained in a text form.

The following step (step 910) consists of analyzing this expression prior to its processing. During this analysis, an internal representation of the XPath expression to be processed is generated. According to one embodiment, this analysis is carried out in a conventional manner by means of a lexical analyzer and a syntactic analyzer.

The algorithm continues at step 920, during which, from this internal representation, the target nodes corresponding to the XPath expression are generated.

To do this, the XPath expression is analyzed.

Thus, for each lexical unit of the “location step” type (“location step” in English terminology), a target node is created.

A target node corresponds to the node test contained in the location step.

In addition, a target node is created to represent the root of the search. According to the type of XPath expression, the root of the search is either the root of the XML document or the current element of the XML document.

If two identical target nodes are created, then they are grouped together in a single element.

The relationships between the various location steps are analyzed and stored in links between the various target nodes.

For two successive location steps of one and the same location path, the relationship corresponds to the filiation relationship towards the second location step.

In the other cases, the relationship depends on the filiation relationship of one of the location steps and the semantics of the XPath elementary sub-expression linking the two location steps.

Thus, for a location step present in a predicate of another location step, the relationship between these two steps corresponds to the filiation relationship of the location step situated in the predicate.

The links between the various target nodes are created in an order corresponding to the order of the XML document.

In this way, if a target node “c” is an ancestor of a target node “a”, a link is created from the target node “c” to the target node “a”.

Moreover, if a target node has no incident link, then a link between the target node representing the root and this target node is created.

The algorithm continues at step 930, consisting of generating a logical representation corresponding to the XPath expression from the previously generated internal representation.

To do this, the XPath expression is analyzed.

Each lexical unit of the expression is represented by a logic node in a tree, the links between the logic nodes corresponding to the semantic relationships between the lexical units. Thus the entire tree represents the XPath expression in its entirety.

In addition, each logic node representing a lexical unit of the location step type is a link to the corresponding target node. In this way, a target node transmits the events that it filters to the logic nodes, which will in their turn process this information in order to evaluate the XPath expression.

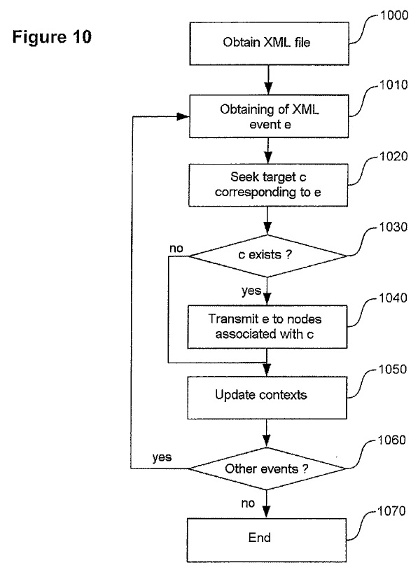

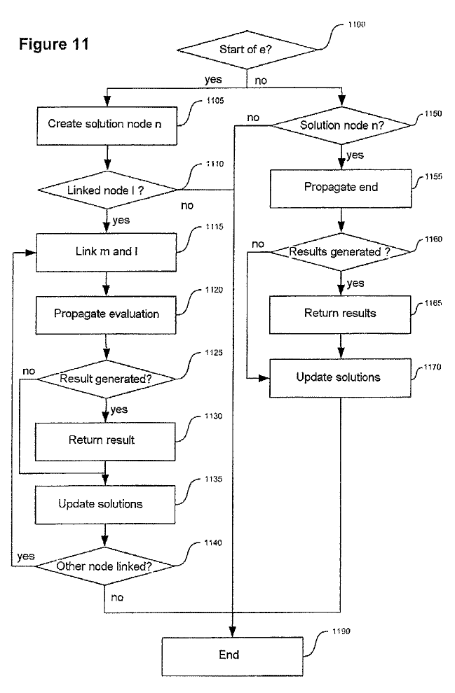

An algorithm for evaluating an XPath expression on an XML document in accordance with the invention is now described with reference to FIG. 10.

This algorithm is preceded by the execution of the algorithm described with reference to FIG. 9 in order to create the various structures necessary for evaluating the XPath expression.

However, a single execution of the algorithm described with reference to FIG. 9 is necessary to then evaluate one and the same XPath expression a plurality of times.

The algorithm in FIG. 10 begins with the step 1000, during which an XML document is obtained.

The XML document can be read from a file, received from a telecommunications network or supplied to the algorithm in any other way.

In order to process the XML document, a parser generates events able to represent the XML document.

Known parsers are for example a parser of the SAX type or a parser of the pull type.

However, a parser of the DOM type can be used by iteration on the XML nodes created by this parser in order to generate the XML events.

The various steps of the algorithm successively process all the events describing the XML document.

Thus the step 1000 is followed by the step 1010, during which a first XML event “e” is obtained.

During this step 1010, the current context is also updated. The current context represents the current position of the XML parser in the XML document. It therefore corresponds to the position of the event “e” within the XML document.

Next the algorithm continues at step 1020, consisting of seeking a target node “c” corresponding to this event “e”.

To do this, all the target nodes of the XPath expression are run through and the event “e” received is compared with the node test represented by the target node.

If the event “e” verifies the node test, then the target node corresponds to this event “e”.

It should be noted that, in the case of an element corresponding to a target node, then the event representing the opening tag of this element and the event representing the closing tag of this element correspond to this target.

The event representing the opening tag is necessary for describing the existence of the corresponding element.

In addition, the event representing the closing tag is necessary for describing the end of the element and allowing on the one hand the valuation of certain functions, for example the counting of the number of children of this element, and on the other hand the updating of certain potential solutions. For example, a predicate relating to the children of an element is entirely evaluated when the event representing the closing tag of the element is received. Thus, when this event is received, the result of the evaluation can be propagated to the rest of the potential solution.

By way of variant, if a target node “c” corresponding to this event “e” is found and this event “e” corresponds to an opening tag of an element, then the target nodes linked to the target node “c” by an incident link have their activation contexts updated. To achieve this updating, for each of these target nodes, a new activation context is created, from the current context and according to the filiation link between the target node “c” and the target node processed.

The algorithm continues at step 1030, during which it is tested whether a target node “c” corresponding to the event “e” exists.

By way of variant, the step 1030 tests, in addition to the existence of a target node “c” corresponding to the event “e”, whether this target node “c” is active. A target node “c” is active if one of the activation contexts of the target node “c” contains the current context.

If such is the case, then the algorithm continues at step 1040, consisting of transmitting the event “e” to the nodes associated with the target node “c”. This step is described in detail below with reference to FIG. 11.

Step 1040 is followed by step 1050.

Likewise, if the test of step 1030 is negative, then step 1030 is followed by step 1050.

During step 1050, the search contexts associated with the various existing solution nodes are verified.

Thus, if the current context no longer belongs to a search context and can no longer belong to it, then the evaluation of the solution node concerned is updated and the result of this evaluation is propagated as described below with reference to step 1120 in FIG. 11.

By way of variant, step 1050 also updates the activation contexts of the target nodes. For each target node and for each of its activation contexts, step 1050 verifies that the current context is situated before the end of this activation context (that is to say either the current context is contained in the activation context or the current context can be contained in the activation context). If such is not the case, this activation context is eliminated.

During the following step (step 1060), it is verified whether other events describing the XML document to be processed remain.

If such is the case, then the algorithm continues at the previously described step 1010, consisting of obtaining the following event.

In the contrary case, the algorithm is ended at step 1070.

An algorithm for constructing the results from the events filtered by the targets according to the invention is now described with reference to FIG. 11.

This algorithm begins with the processing carried out on the events corresponding to a start of an XML item or an end of an XML item.

It therefore applies in particular to the events generated from the XML document representing an opening tag or a closing tag.

Concerning the other events, for example a textual content or a comment, the algorithm is executed twice consecutively, the first to signify the start of the item, the second to signify its end.

According to a particular embodiment, for all the events representing a complete XML item, the two parts of this algorithm corresponding to the processing of the start of the item and of the end of the item are combined in an algorithm performing all the steps contained in these two parts.

When the algorithm described with reference to FIG. 11 is implemented, the event “e” to be processed has been selected by means of a target note “c” during steps 1020 and 1030 of FIG. 10 and is associated with a logic node “r” during step 1040 and FIG. 10.

In addition, if the target node “c” is associated with several logic notes, then this algorithm is implemented for each of these logic nodes.

The algorithm begins at step 1100, consisting of testing whether the event “e” processed is a start of item event or an end of item event.

If the event is a start of item event, then the algorithm continues at the step of 1105 of creating a solution node “n” to represent the item.

This solution node stores the item represented and its position in the XML document.

In addition, if the logic node “r” is linked to other logic nodes descending from this logic node “r” in the logic representation and representing functions or operators, then a solution node is created for each of these logic nodes. These newly created solution nodes are linked to the solution node “n”.

In addition, for each of the location paths that is the child of one of the solution nodes created, the search context for this location path is stored. This search context depends in particular on the solution node “n” and the filiation relationship linking the solution node to the location path. This search context makes it possible for example to determine the end of the solution search for the location path in question.

Thus, in the example illustrated in FIGS. 1 to 7, when an event corresponding to an element “a” associated with the logic node 300 is processed, a solution node is created to represent this element “a” and another solution node is created to represent the operator “and” described by the logic node 320. On the other hand, when an event corresponding to an element “c” associated with the logic node 350 is processed, then only the solution node representing the element “c” is created.

In addition, when this element “a” is created, a search context is created for the solution nodes created with the logic node 310, “ctx-a”. This search context is associated with the solution node representing this element “a”.

Two other search contexts are created for the solution node representing the operator “and”, the first context corresponding to the solution nodes associated with the logic node “ctx-b” referenced 330 in FIG. 3, the second context corresponding to the solution nodes associated with the logic node “ctx-c” referenced 340 in FIG. 3.

The search context “ctx-c” has been fully explored, and thus no solution node “c” that can be linked to the solution node “a” can any longer be found. If a solution node “c” that can be linked to the solution node “a” does not yet exist, the solution node “a” cannot be integrated in a solution of the XPath expression and can therefore be destroyed immediately.

The algorithm continues with the search for solution nodes linked to one of these newly created solution nodes.

It is considered that two solution nodes are linked if they satisfy two conditions: firstly they must correspond to logic nodes of the expression connected to each other and secondly the relationship between these two solution nodes must correspond to the semantic relationship between the logic nodes.

Thus, in the example considered in FIGS. 1 to 7, when the event corresponding to the element “b” illustrated at reference 430 in FIG. 4, associated with the logic node 330 in FIG. 3, is processed, the solution node representing this event is linked to the solution node representing the logic node 320 in FIG. 3 associated with the solution node representing the element “a” referenced 425 in FIG. 4 associated with the logic node 300 in FIG. 3.

This is because the logic nodes 300 and 330 in FIG. 3 are linked by a filiation relationship of the child type (“child” according to the XPath specification), which effectively corresponds to the relationship between the two elements “b” (430) and “a” (425).

On the other hand, the solution node representing this element “b” (430) associated with the logic node 330 in FIG. 3 is not linked to the solution node representing the element “a” referenced 435 in FIG. 4 associated with the logic node 300 in FIG. 3. This is because the element “b” (430) is not the child of the element “a” (435).

The previously described step 1105 is followed by step 1110, consisting of testing whether there exists a solution node “I” linked to a solution node “m” among the new solution nodes created during step 1105.

If not, the algorithm is ended at step 1190.

In the contrary case, the algorithm continues at step 1115, consisting of linking the solution node “I” to the solution node “m”.

Step 1115 is followed by step 1120, consisting of propagating the evaluation.

The propagation of the evaluation consists of verifying whether the event received makes it possible to move forward in the evaluation of the XPath expression.

Several cases present themselves for the propagation of the evaluation, according to the type of logic node corresponding to the solution node “m”. In a first case, a logic node corresponding to the solution node “m” is a location step. In a second case, the logic node corresponding to the solution node “m” does not represent a location step.

If the logic node corresponding to the solution node “m” represents a location step, then the algorithm checks whether there exists a complete solution for this location path.

To do this, it is checked whether there exists a set of solution nodes linked together and corresponding to the various steps of the location path.

One and only one solution node in all the solution nodes must correspond to each step of the location path. However, several sets of solution nodes can be tested to cover all the solution nodes corresponding to each step of the location path.

In addition, for each solution node of this set, it is verified that all the predicates associated with this solution node are evaluated positively.

For each complete solution thus found, a result is generated for the location path.

When the results are generated, it is verified that the results are generated only once and that they are generated in the appropriate order. It should be noted that a result may be generated by two different sets of solution nodes.

Thus, after the creation of the solution node associated with the logic node 310 in FIG. 3 representing the element “a” referenced 435 in FIG. 4, it is checked whether there exists a solution node associated with the logic node 300 linked to this first solution node.

In the example in question, there exists such a solution node, it is the solution node representing the element “a” referenced 425 in FIG. 4. Thus, for each of the steps of the location path, there exists a solution node corresponding to this step.

In addition, it is checked whether the predicate of this second solution node is verified. In the example in question, a single element “b” that is a child of the element “a” referenced 425 in FIG. 4 has been found at this time, and the predicate is therefore not verified. Consequently, in the example in question, there does not exist any complete solution for the location path. No result for this location path can therefore be returned.

In the case where the result generated by a location path does not correspond to the principal expression of the XPath expression evaluated, then this result is propagated to the parent solution nodes of the complete solution that generated the result. These are solution nodes that are parents of the solution node of the first step of the location path belonging to the complete solution. In addition, this result is stored at the first step of the location path belonging to the complete solution so as to be able to be used subsequently by new solution nodes linked to this location path.

Each parent solution node is then re-evaluated, taking into account this new result. Two cases may present themselves.

According to a first case, the evaluation of the parent solution node is terminated. The result of this evaluation is then retransmitted in the same way to the parent solution nodes of this parent solution node.

In a second case, the evaluation of the parent solution node is not terminated and no other action is performed at this parent solution node.

The evaluation of a solution node after the reception of a result depends on the type of element of the XPath expression represented by this solution node. If it is a case of a location step, the algorithm checks whether there exists a complete solution for this location path as described previously. In such a case, the result corresponds to the evaluation of a predicate of this location step and can therefore make it possible to find a complete solution for the location path in which this location step belongs.

If it is a case of a function, the algorithm attempts to evaluate the function. To do this, it is checked whether all the data necessary for the evaluation of the function has been received. For this purpose, the search context linked to this solution node is used to determine whether all the data constituting the arguments of the function is known or not. It should be noted that certain functions can be evaluated even if some other arguments are not yet entirely known. If all the data necessary for evaluating the function has been received, the function is evaluated. In the contrary case, the result or part of the result is stored in order to be able to evaluate the function subsequently.

If it is a case of an operator, the algorithm attempts to evaluate the operator. This evaluation is performed in a similar manner to the evaluation of a function.

In the last two cases, if the function or operator can be evaluated, the result of this evaluation is transmitted to the parent solution nodes of the solution node corresponding to the function or to the operator. These parent solution nodes are in their turn evaluated as described previously. In addition, the result of the evaluation is stored at the solution node corresponding to the function or to the operator in order to be able to be used subsequently.

The second case for the propagation of the evaluation is the one where the logic node corresponding to the solution node “m” does not represent a location step. The logic node can thus represent a function, or an operator.

In this case, the algorithm attempts to evaluate the function or the operator, as described previously. In addition, if the function or operator can be evaluated, the result of this evaluation is transmitted to its parent solution nodes in order to propagate the evaluation.

Step 1120 is followed by step 1125, consisting of testing whether certain results generated during step 1120 correspond to the principal expression of the XPath expression evaluated.

If such is the case, then the algorithm continues at step 1130, consisting of returning these results. The following step is 1135.

During step 1125, if the test is negative, then the following step is step 1135.

This step (step 1135) consists of performing an updating of the solution nodes.

To do this, the algorithm commences by considering a set of solution nodes. This set of solution nodes comprises the solution nodes corresponding to a location step, a predicate of which has been evaluated falsely, and the solution nodes corresponding to the last step of the location path of the result and representing an event corresponding to a result generated during step 1120.

All the solution nodes considered are then eliminated.

Next there are also eliminated the solution nodes not representing a location step and descending from one of these eliminated solution nodes, either directly, or indirectly by means of other solution nodes not representing a location step.

Finally, the descendants of one of the solution nodes previously eliminated corresponding to location steps are examined. For each of these nodes, two criteria are verified. Firstly, the solution node must not be a child of another existing solution node. Secondly, the solution node must not be able to be a child of a future solution node not yet created. This second criteria is verified in particular by analysing the relationship of the logic node corresponding to the solution node with its parent logic nodes. If these two criteria are satisfied for a solution node, then this solution node is eliminated and any descendants of it are in their turn examined in the same way.

The algorithm then continues at step 1140 in order to check whether there remain other nodes linked to the previously created nodes.

If such is the case, then the algorithm continues at the previously described step 1115.

In the contrary case, the algorithm is ended at step 1190.

Returning to step 1100, in the case where the event “e” corresponds to the end of an XML item, for example to a closing tag for an XML element, the algorithm continues at step 1150, during which it is sought whether there exists a solution node “n” corresponding to the event “e” and to the logic node “r”.

If such is not the case, then the algorithm ends at step 1190.

If on the other hand a solution node “n” is found, then the algorithm continues at step 1155, consisting of propagating the end of item event.

The propagation of the end of item event consists of terminating all the evaluations that could not be terminated before the end of this item.

To do this, all the descendant solution nodes of the solution node “n” are run through and, for each of these solution nodes, it is checked whether the end of item event is useful for evaluating this solution node. During this check, the search context corresponding to a solution node is used to check whether the end of item event indicates the end of the search context and therefore the end of the evaluation of the solution node.

If such is the case then the evaluation is carried out. If this evaluation is terminated, then it is propagated as described previously.

For example, in the case of an expression of the “a/b[position( )=last( )]”, the end of element “a” makes it possible to calculate the value of “last( )” for this event.

Step 1155 is followed by step 1160, making it possible to test whether results have been generated by the end of item propagation. This step is similar to step 1125.

If such is the case, then the algorithm continues at step 1165, during which these results are returned. This step is similar to step 1130. The following step is step 1170.

If the test of step 1160 is negative, then the algorithm continues at step 1170 of updating the solutions.

Step 1170 is similar to step 1135. However, it differs from this through the set of solution nodes considered. This is because, in addition to the solution nodes corresponding to a location step, a predicate of which has been falsely evaluated, and solution nodes corresponding to a result generated, in certain cases the solution node “n” is added to this set of solution nodes.

The solution node “n” is effectively added to this set of solution nodes if there exists a logic node “rp” representing a location step directly linked to the logic node “r” or indirectly by means of logic nodes not representing a location step and satisfying two conditions. Firstly, no solution node corresponding to this logic node “rp” has been associated with the solution node “n”. Secondly, it is no longer possible to find a solution node corresponding to this logic node “rp” and able to be associated with the solution node “n”. For a logic node “rp” that is a descendant of the logic node “r” associated with the solution node “n”, a second condition can be evaluated by means of the search context for “rp” associated with the solution node “n”.

Thus, in the case of the expression “/a/b”, during the processing of the event representing the closing tag of an element “a”, if no solution node representing an element “b” that is a child of this element “a” has been found, then the solution node representing “a” is eliminated.

The same situation occurs also when the expression “/a[b]” is evaluated.

Step 1170 is followed by step 1190, ending the algorithm.

In order to implement the method of evaluating an expression on elements of a structured document, a device for evaluating an expression on elements of a structured document comprises in particular means of generating, from the expression, a set of target notes corresponding to items to be sought in the structured document; means of generating a logical representation of the expression, a logical representation comprising a set of nodes, representing the elementary sub-expressions of the expression, linked according to relationships between these elementary sub-expressions; and means of evaluating the expression on items of the structured document from all the target nodes generated and the logical representation generated.

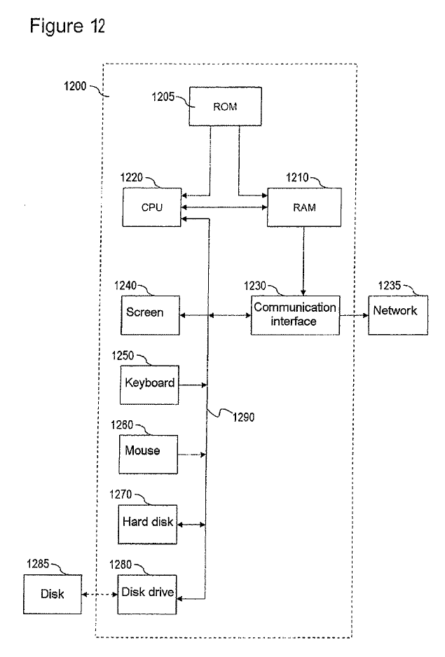

This device for evaluating an expression on elements of a structured document can be incorporated in a computer 1200 as illustrated in FIG. 12.

In particular, the various means identified above can be incorporated in a read only memory 1205, or “ROM” adapted to store a program for evaluating an expression on elements of a structured document in accordance with the invention.

The Random Access Memory 1210, or “RAM” is adapted to store in registers the values modified during the execution of the program for evaluating an expression on elements of a structured document.

The microprocessor 1220 is integrated in a computer 1200, which can be connected to various peripherals and to other computers in a communication network.

This computer comprises in a known manner a communication interface 1230 connected to the communication interface 1235 in order to receive or transmit messages. The computer also comprises means of storing documents, such as a hard disk 1270, or is adapted to co-operate by means of a disk drive 1280 (diskettes, compact disks or computer cards) with removable document storage means, such as disks 1285. These fixed or removable storage means can contain the code of the method of evaluating an expression on elements of a structured document in accordance with the invention.

They are also adapted to store an electronic document containing hierarchized data as defined by the present invention.

By way of variant, the program enabling the device for evaluating an expression to implement the invention can be stored in the read only memory 1205.

In a second variant, the program can be received in order to be stored as described previously by means of the communication network 1235. The computer 1200 also has a screen 1240 serving for example as an interface with an operator by means of the keyboard 1250 or the mouse 1260 or any other means.

The central unit 1220 (CPU) will then execute the instructions relating to the implementation of the invention. On powering up, the programs and methods relating to the invention stored in a non-volatile memory, for example the memory 1205, are transferred into the memory 1210, which will then contain the executable code of the invention as well as the variables necessary for implementing the invention.

The communication bus 1290 affords communication between the various sub-elements of the computer or connected to it.

The representation of this bus 1290 is not limiting and in particular the microprocessor 1220 is able to communicate instructions to any sub-element directly or by means of another sub-element.

Naturally, many modifications can be made to the example embodiments described above without departing from the scope of the invention.

The invention consists of evaluating predicates in an expression, in particular in an XPath type expression by using a parser, for example a SAX type parser. For this, the evaluation of the predicates is carried out by creating a table representing the evaluation state of each predicate for each of the candidate elements. Next, progressively as the XML document is gone through, the predicates evaluation table is updated by adding rows for the new candidate elements and by modifying the evaluation results of the predicates. The grouping together of the set of evaluation states for the different candidate elements makes it possible to improve their evaluation if those evaluations are interdependent, in particular in the case of predicates concerning the position of an element.

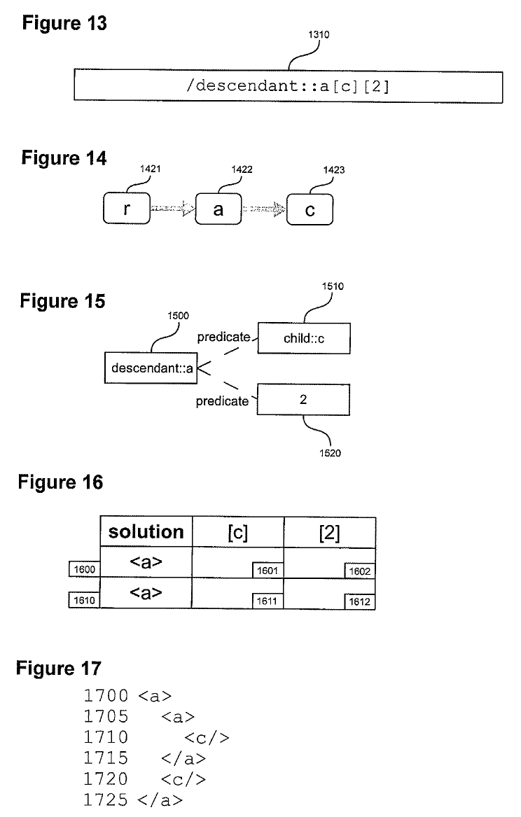

The expression 1310 in FIG. 13 illustrates an example of an XPath expression able to be processed according to the invention.

According to this expression, a search is made among the elements “a” situated at any depth in the document for the elements “a” having a child element “c”, and the second element “a” having a child “c” is selected.

The case is described below in which the predicates apply to a location step, as in the example of the expression 1310 of FIG. 13. However, the invention equally well applies to the other cases of use of predicates such as the FilterExpressions of the XPath standard. Thus the invention may apply to the following XPath expression:

(/descendant::a or /descendant::b)[c][2]

which searches among the elements “a” or “b” situated at any depth of the document, for those which have a child element “c”, and among these latter, selects the second.

FIG. 14 represents all the target nodes generated in accordance with the invention from the XPath expression 1310 of FIG. 13.

The target nodes of FIG. 14 correspond to the XML nodes sought for evaluating the XPath expression. The target node “r” (target node 1421) corresponds to the root of the XML document, and the target node “a” (target node 1422), and the target node “c” (target node 1423) correspond to the elements sought in the XML document by means of the XPath expression.

The target nodes are used to filter the events received by the entity able to perform the evaluation of an XPath expression relative to an XML document, also called an XPath processor. Thus the target nodes correspond to the node tests of the XPath expression. For each node test of the XPath expression, a target node is generated. However, if several identical target nodes are generated, they are grouped together in a single target node.

In addition, in order to optimize the process of searching for the nodes, the target nodes are organized according to their relationships of order of appearance in the document and as they are defined by the filiation relationships of the XPath expression.

In this way, according to the example illustrated in FIGS. 13 and 14, an element “c” is sought only after having found an element “a”.

These relationships of order of appearance are shown in FIG. 14 by arrows. The search process is optimized further by a precise description of the order of appearance relationships expressed in the XPath expression.

Thus, according to the example illustrated in FIGS. 13 and 14, a relationship between the target “a” and the target “c” is in particular a “difference in depth of exactly one”.

FIG. 15 illustrates a logical representation of the XPath expression 1310 of FIG. 13 in accordance with the invention.

This logical representation makes it possible to evaluate the XPath expression from the nodes filtered by the target nodes generated as described in FIG. 14.

According to this logical representation, each elementary sub-expression of the XPath expression is represented by a logic node.

For example, the elementary sub-expression “descendant::a” is represented by a logic node “descendant::a”.

The links between the logic nodes describe their relationships within the XPath expression.

During the evaluation of an XPath expression, this logical representation also makes it possible to construct the solutions of the XPath expression.

For this purpose, a logic node receives the events filtered by the target nodes and uses them to construct solution nodes representing this event within a potential solution for the XPath expression. Each solution node represents a value verifying an elementary part of the XPath expression. The elementary part of the XPath expression verified by the solution node corresponds to the logic node associated with this solution node. A potential solution groups together a set of solution nodes, complying with the logic of the XPath expression. When a potential solution contains a solution node for each logic node of the XPath expression, this potential solution satisfies the whole of the XPath expression and therefore makes it possible to generate a solution for the XPath expression.

Thus, when an event “a” is received, it is detected by the target node “a” of FIG. 14 and transmitted to the logic node “a” of FIG. 15, i.e. the logic node “descendant::a” 1500.

On the basis of that event “a”, the logic node 1500 updates a potential solution of the XPath expression by creating one or more solution nodes representing that event “a”.

In FIG. 16 there is illustrated an example of a table representing the state of the evaluation of the predicates “[c]” and “[2]” of the XPath expression 1310 for the elements “a” encountered on processing of the structured document, in particular according to the XML language, illustrated in FIG. 17. The table comprises, for example three columns, the first identifying the solution nodes corresponding to elements “a”, the second, the evaluation of the predicate “[c]” and the third, the evaluation of the predicate “[2]”.

Thus, for each element “a” of the structured document, a new row is added to the table. This row is completed progressively on going through the XML document to allow the evaluation of all the predicates of each element “a”.

An example of an XML document to which the XPath expression 1310 of FIG. 13 can be applied is now described with reference to FIG. 17.

According to this example, the result of the evaluation of the XPath expression 1310 on the XML document of FIG. 17 is the second element “a” of this XML document.

When the XML document is processed by the SAX parser, events describing the XML document are transmitted to the XPath processor.

These events enable the XPath processor to update the predicates evaluation table of FIG. 16, and thus to evaluate the predicates for the different elements “a” of the XML document.

The actions of the XPath processor whose object is the evaluation of the XPath expression relating to the XML document described by these events are now described.

On reception of the “Start document” event, this is received by the target node “r” 1421. This target node creates a solution node “r” to represent that event. In addition, the target node “a” 1422 is activated, with an activation context corresponding to the whole of the XML document.

Furthermore, the predicates evaluation table of FIG. 16 is created in order to store the evaluation state of the predicates for the different elements “a” of the XML document.

Next, on reception of the opening tag event “a” corresponding to the opening tag “a” of line 1700, that event is received by the target node “a”. The target node “c” is activated with an activation context corresponding to all the child nodes of this element “a”. In addition, a solution node “a1” is created to represent this event and is associated with the solution node “r” as a child of this node.

Furthermore, the predicates evaluation table of FIG. 16 is modified by adding a row (1600) in order to store the evaluation state of both predicates (“[c]” and “[2]”) for that element “a”. As the evaluation of these predicates cannot be carried out immediately, the values of the cells 1601 and 1602 are initialized to the value “unknown”.

The XML document next comprises an opening tag “a” 1705. The corresponding event is processed in similar manner to the previous one. A solution node “a2” is created to represent that event. Furthermore, the activation context of the target node “c” is extended to include all the child nodes of that second element “a”.

In addition, a second row is added to the predicates evaluation table of FIG. 16 (line 1610) in order to store the evaluation state of both the predicates for that second element “a”. As for the previous element, since the evaluation of the predicates cannot be carried out immediately, the values of the cells 1611 and 1612 are initialized to the value “unknown”.

Next, the following event is the opening tag “c” corresponding to the empty element “c” 1710. This event is received by the target node “c”. A solution node “c1” is created to represent that element “c”. This solution node is not linked to the solution node “a1” representing the first element “a” (1700), since the relationship between that element “c” and the first element “a” does not correspond to a “child” type relationship. On the other hand, that solution node is linked to the solution node “a2” representing the second element “a” (1705). In this way, it is thus possible to evaluate the predicate “[c]” for that second element “a”. The value of the cell 1611 thus becomes “true”. However, it is not yet possible to evaluate the predicate “[2]” for that second element “a” since this evaluation depends on the evaluation of the predicates of the first element “a”.

The following event is the closing tag “c” corresponding to the empty element “c” 1710. This event induces no modification in the evaluation of the XPath expression.

The following event is the closing tag event corresponding to the closing tag of the element “a” 1715. This event is received by the target node “a”. Given that the predicates remaining to evaluate for that second element “a” (the predicate “[2]”) do not depend on the content of the element “a”, row 1610 of the predicates evaluation table of FIG. 16 is kept. This means that the element “a” remains a possible result for the evaluation of the XPath expression.

However, if some predicates remaining to evaluate for that second element “a” were to depend on the content of the element “a”, row 1610 of the evaluation table would be deleted at this step: This is because the element “a” would not be a possible result for the evaluation of the XPath expression.

The following event is the opening tag event corresponding to the empty element “c” 1720. This event is received by the target node “c”. A solution node “c2” is created to represent that element “c”. That solution node is linked to the solution node “a2” representing the first element “a” (1700). In this way, it is thus possible to evaluate the predicate “[c]” for that first element “a”. The value of the cell 1601 thus becomes “true”. Moreover, it is possible to evaluate the position of that first element “a” with respect to all the elements “a” having a child “c”. More particularly, the position of that first element “a” is the first and thus has the value 1. Consequently, the evaluation of the predicate “[2]” for that first element is negative. The value of the cell 1602 is thus “false”. Thus, all the predicates concerning that first element “a” are not verified and that element “a” is thus not a solution for the XPath expression 1310. That element “a” cannot therefore be deleted from the predicates evaluation table of FIG. 16.

Furthermore, given that the evaluation of all the predicates for the first element “a” has been terminated, and that in particular the evaluation of the predicate “[2]” for that first element “a” has been terminated, it is possible to evaluate the predicate “[2]” for the second element “a”. As this second element “a” is the second element “a” of the document having a child “c”; that predicate is positively evaluated and the value of the cell 1612 is thus “true”. Thus, the second element “a” is a solution of the XPath expression. More particularly, this second element “a” is indeed a second element “a” situated at any depth with respect to the first element “a” and having a child element “c”. This second element “a” is thus yielded as solution to the XPath expression 1310. Furthermore, row 1610 is deleted from the predicates evaluation table of FIG. 16.

The following event is the closing tag “c” corresponding to the empty element “c” 1710. This event induces no modification in the evaluation of the XPath expression.

The next event is the empty tag event “a” 1725. This event is received by the target node “a”. The target “c” is then deactivated. Given that there is no solution awaiting, no other action is made.

If a second XML document example similar to that described in FIG. 17 is considered in which line 1720 is absent, the action succession that makes it possible to finalize the evaluation of the predicates is then the following. The consequence of the event signaling the closing tag of the first element “a” (1725) is that the predicate “[c]” cannot be verified for that element “a”. That first element “a” is thus deleted from the table. Consequently, it has become possible to finish the evaluation of the predicates for the second element “a”. In particular, the predicate “[2]” is then evaluated as “false” for that element, since in that case, the second element “a” is the first element “a” of the document having a child “c”. This second element “a” is thus also deleted from the table. According to this example, no result is yielded, which corresponds to the result expected from the evaluation of the XPath expression.

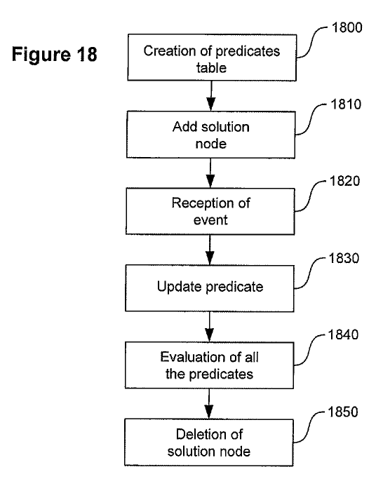

A description is now given with reference to FIG. 18, of a general algorithm for evaluation of the predicates for an XPath location step in accordance with the invention and adapted for the evaluation of predicates whatever the XPath expression or sub-expression. The first step of this algorithm (step 1800) consists of creating a table adapted to store the evaluation of the predicates of an XPath location step to evaluate. This table is attached to the solution node representing the context of the location step for which it stores the results for the predicates.

Consequently, according to one embodiment, the table is created at the same time as the context solution node.

Several tables may also be created for the same location step. For example, if the XPath example is the following: “/b/descendant::a[c][2]”, a table for evaluation of the predicates is created for each element “b” found at the depth 1.

According to a particular embodiment, in addition to that table, another table is created in order to store the number of results found. This table, called counting table, has a number of cells equal to the number of predicates plus 1. This is because the first cell stores the number of elements found verifying the node test of the location step, the second cell stores the number of elements found additionally verifying the first predicate and so forth. On creation of this counting table, its cells are all initialized with the value “0”.

Step 1800 is followed by step 1810 consisting of adding a solution node for the location step concerned. This step is carried out each time an event corresponding to the location step is received.

During this step, the counting step storing the number of solutions is also updated.

Furthermore, a new row is inserted in the table for evaluation of the predicates storing the results of the evaluation of the predicates linked to that solution node.

This row of the table stores the solution node in the first column. The other cells of the row are filled depending on the type of the predicate. Thus, for a predicate corresponding to a location path, the cell is initialized to a “not-found” value. For a predicate corresponding to an expression necessitating the creation of a solution node, for example a function call or an arithmetic expression, that node is created and stored in the cell. Lastly, in the other cases, the cell stores a value “not-evaluated”. These other cases correspond to very simple expressions capable of being evaluated on the basis of the context, which is in particular the case of the position predicates.

Lastly, the algorithm attempts to evaluate the predicates for that new solution node. This evaluation is possible if, for example, a predicate refers to an element preceding that represented by the solution node, or if a predicate contains an expression which may already be calculated.

The following steps consist of updating the evaluation of the predicates for a solution node stored in the table.

The first step of the updating (step 1820) consists of receiving an XML event describing a part of the XML document in relation to which XPath expression is evaluated.

The following step (step 1830) consists of updating one of the predicates associated with the solution node according to that received XML event. This step is executed in particular when the event makes it possible to continue the evaluation of a predicate associated with the solution node created earlier.

In the case of a predicate corresponding to a location path, the updating of the predicates evaluation table is carried out when the result is found for that location path. This result is then used to update the row of the predicates evaluation table corresponding to the solution node. The cell of the predicates evaluation table for the predicate and the location path considered then takes the value “found”.

If it is no longer possible to find a result for the location path, the cell of the table for the predicate and the location path considered take the value “cannot be found”.

In the case of a predicate corresponding to an expression necessitating the creation of a solution node, the updating of the predicates evaluation table takes place when the expression is evaluated.

It is to be noted that in these two cases, the same event may be used to update the predicates for several solution nodes of the table. Advantageously, the updating steps may be factorized for all the solution nodes concerned.

Next, step 1840 consists of re-evaluating all the predicates for the solution node.

This step makes it possible to process the cases other then the two predicates cases described at step 1830. In this last case, the updating of the table for the predicate is the consequence of another updating of the table, that other updating making it possible to have the necessary information to evaluate said predicate.

It is to be noted that the updating of the evaluation of a predicate accompanies the updating of the number of results found.

Furthermore, after the updating of the evaluation of the predicates for the solution node, all the predicates for all the solution nodes stored in the predicates evaluation table are re-evaluated. This makes it possible in particular to update the predicates dependent on the result of evaluating another predicate.

The following step (step 1850) consists of deleting a solution node. This deletion may arise either when all the predicates of the solution node are verified, or when one of the predicates of the solution node is invalidated.

In the first case, the solution node is completely validated. It may thus participate in the construction of a result. In the case in which the solution node corresponds to the last step of a location path, that is to say that the solution node represents a result, a particular processing operation is implemented to yield the result, in particular in the right order.

In the second case, the solution node is not validated, and may thus be deleted from the table.

It is to be noted that the steps 1810, 1820, 1830, 1840 and 1850 are generally carried out several times and that the order of these steps is only set in their execution in relation to the same solution node. Furthermore, steps 1820, 1830 and 1840 are generally carried out several times for each solution node.

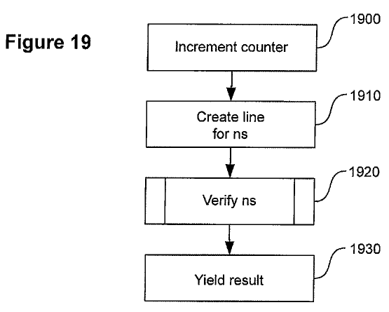

A description will now be given, with reference to FIG. 19, of processing operations to carry out on creation of a new solution node ns.

The algorithm begins at step 1900 with the updating of the counting table by the incrementation of the first cell of that table.

The following step (step 1910) consists of creating a new row in the table to represent the evaluation of the predicates of the solution node ns. Furthermore, each of the cells of the row is initialized depending on the type of its associated predicate.

For a predicate corresponding to a location path, the cell is initialized to a “not-found” value.

However, if the location path corresponds to an item of the XML document situated before the one represented by the solution node ns and if on creation of the solution node ns, this has been associated with a set of solution nodes constituting a result for the location path, then the cell is initialized to the value “found”.

On the other hand, if the location path corresponds to an item of the XML document situated before the one represented by the solution node ns, and if no set of solution nodes constituting a result for that location path has been associated with the solution node ns at the time of its creation, then the cell is initialized to the value “cannot be found”.

In the case of a predicate corresponding to an expression necessitating the creation of a solution node, that node is created (as well as all the associated solution nodes to be created to evaluate the expression) and stored in the cell.

Lastly, in the other cases, the cell stores the value “not-evaluated”.

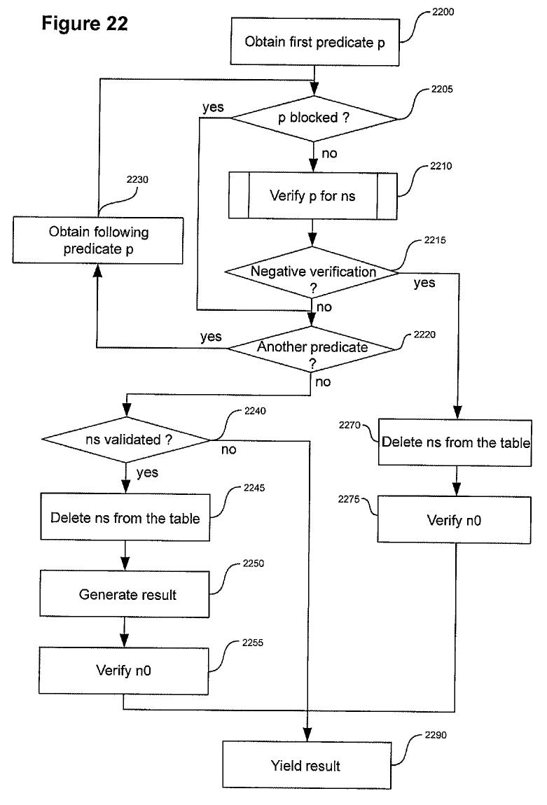

The following step (step 1920) evaluates a first time the predicates of that solution node ns. For this, an algorithm for verifying the predicates is invoked for the solution node ns. Such an algorithm is described below with reference to FIG. 22.

Lastly (step 1930), if the verification of the predicates has generated one or more results, these are yielded.

According to the position of the location step corresponding to the solution nodes generated by the table, the results may be used in several ways according to whether the location step is situated at the end of the location path or not.

If the location step is not situated at the end of the location path, a result makes it possible to validate the corresponding solution node as entirely verified, that is to say that the node test and all the predicates have been verified.

On the contrary, if the location step is situated at the end of the location path, the result constitutes a possible result for that location path. Thus, if for a result, the whole path is verified, that is to say that for each location step, there is a fully verified solution node, the result may be yielded as a result of the location path.

Where the location path constitutes the main expression of the XPath expression, the result of the evaluation of the predicate is one of the results of the XPath expression.

Where the location path constitutes the content of a predicate, the result makes it possible to validate that predicate, then that result is transmitted to the associated solution nodes having that predicate to update their predicates evaluation table.

In the other cases, the result is transmitted to the parent solution node of the location path to be integrated into the evaluation of the parent node.

It is to be noted that to manage the order of the results, the transmission of the results may be indirect. To that end, the transmission may be filtered by a structure which manages all the results produced by a location path for a given context.

When a solution node corresponding to the last location step of the path is created, that result node is added to the list managed by the structure.

When a solution node is deleted, it is deleted from the list managed by the structure.

Lastly, when a result is generated, the corresponding solution node is marked specially in the structure.

If that result is the first solution node of the list, it is transmitted, otherwise it is placed on standby.

Each time the first solution node of the list is transmitted as a result or deleted from the list, the following solution node is verified and transmitted if it was on standby.

Where the location path corresponds to a sub-expression of the XPath expression, but this does not have any parent solution node, the result is stored to be used later when a solution node is associated with the location path as a parent.

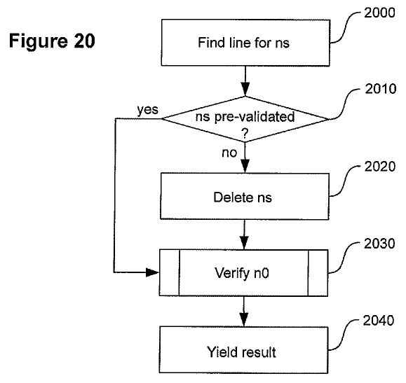

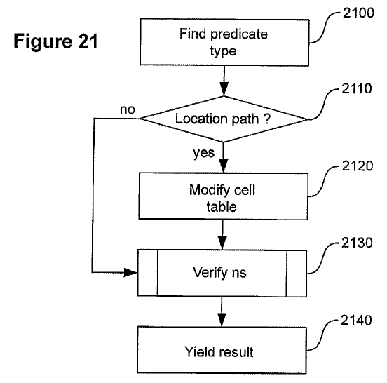

A description will now be given, with reference to FIG. 20, of the processing operations to carry out on deletion of a solution node ns. The deletion of a solution node occurs when no further event on which that node depends for its complete evaluation can occur.

The algorithm begins at step 2000 consisting of determining the row of the predicates evaluation table corresponding to the solution node ns.

Step 2000 is followed by step 2010 during which it is verified whether that solution node is pre-validated, that is to say that it is verified whether all the events necessary for the positive evaluation of the predicates have been received.

This is because certain predicates may not yet be capable of being calculated due to the unfinished evaluation of predicates of other solution nodes. In the example considered in FIG. 17, this is in particular the case for the element “a” of row 1705.

For each predicate, this verification depends on the type of the predicate.

For a predicate corresponding to a location path, the cell must have the value “found”.

For a predicate corresponding to an expression necessitating the creation of a solution node, all the location paths descending from that solution node must have a result. Furthermore, that predicate must not be negatively evaluated.

Lastly, for the other predicates, these must not have been evaluated negatively.

If, at step 2010, the test verifying whether that solution node is pre-validated is negative, the algorithm continues at the step 2020 during which the solution node is deleted and the corresponding line is destroyed.

Step 2020 is followed by the step 2030 described above.

If, on the contrary, the test of step 2010 is positive, the solution node is kept. This is because, this solution node may generate a result when all of its predicates have been evaluated. It is even possible that all the predicates of that solution node have already been verified, but that the corresponding result has been put on standby in order to be yielded in the right order.

This step is followed by the step 2030.

At this step (step 2030), the solution node stored in the first row of the table n0 (if it exists) is verified. This is because the updating of the solution node ns may enable the evaluation of other solution nodes to progress. This is in particular the case if the solution node ns has been deleted from the table.

According to a variant embodiment, to economize on memory, all the solutions nodes stored in the predicates evaluation table may be verified again.

Lastly, the algorithm terminates at step 2040 during which the algorithm yields one or more results, if there are any, as also stated at step 1930 of FIG. 19.

A description is now given, with reference to FIG. 21, of the processing operations to perform to update the predicates evaluation table. This algorithm is implemented each time a new piece of information is able to allow continuation of the evaluation of the predicates of the solution nodes contained in the first column of the evaluation table. This algorithm is implemented in particular in the following cases.

This algorithm is implemented, in particular, on producing a result on evaluating a location path representing a predicate of a solution node stored in the table. For this, the algorithm is invoked, with the solution node ns and the identification of the predicate p as parameters.

Moreover, the algorithm is implemented on completing the evaluation of a solution node stored in the predicates evaluation table, the solution node representing a predicate constituted by an expression. For this, the algorithm is invoked, with the solution node ns that is parent to that solution node completely evaluated and the identification of the corresponding predicate p as parameters.

The algorithm commences at step 2100 which consists of determining the type of the predicate p.

Step 2110 follows step 2100 during which the predicate is tested in order to determine whether that predicate corresponds to a location path.

In the negative case, the algorithm continues at step 2130 described below.

In the positive case, the algorithm continues at the step 2120 during which the corresponding cell of the predicates evaluation table is modified to take the value “found”. Step 2120 is followed by step 2130.

Step 2130 consists of verifying the predicates for the solution node ns.

Lastly, the algorithm terminates, at step 2140, by yielding one or more results, if there are any, as stated with reference to step 1930 of FIG. 19.

A description will now be given with reference to FIG. 22 of the processing operations to carry out to verify all the predicates for a solution node ns.

The algorithm begins at step 2200 which consists of obtaining the first predicate p.

Step 2200 is followed by step 2205 during which it is verified whether that predicate p is “blocked” or not. A predicate is said to be “blocked” for a solution node ns when its evaluation has not yet been carried out for a solution node stored in a preceding row of the table.

In a variant embodiment, a predicate is also considered as “blocked” if, for any one of the preceding predicates, the verification step 2210 has yielded an indeterminate result. In this variant embodiment, if the predicate is blocked, the algorithm can directly continue at step 2290.

According to another variant embodiment, a predicate is said to be “blocked” solely if its evaluation necessitates the evaluation of that same predicate for a solution node stored in a preceding row of the table. This is the case for example for a predicate concerning the position of the solution node.

If the predicate is blocked, the algorithm continues at step 2220 described below.

In the opposite case, the algorithm continues at the step 2210 during which it is verified whether the predicate p is validated for the solution node ns.

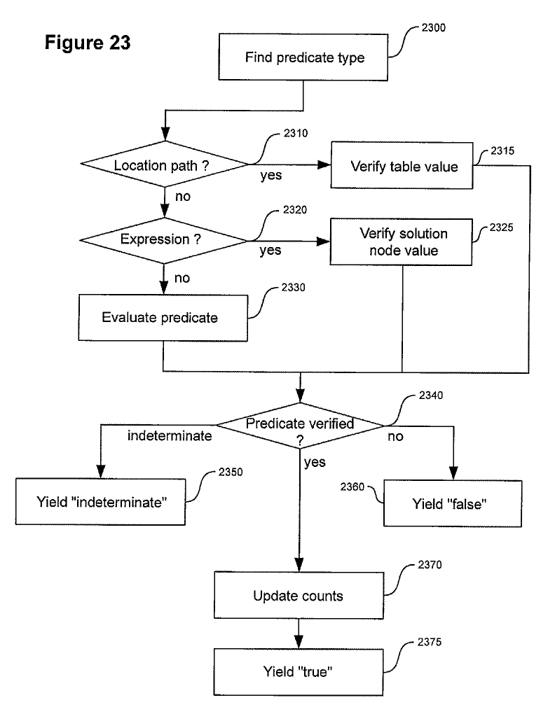

This verification, described below with reference to FIG. 23, may yield a positive, negative or indeterminate result.

The following step (step 2215) consists of testing the verification carried out at step 2210.

If the verification is negative, the algorithm continues at step 2270 described below.

On the contrary, if the verification is positive or indeterminate, the algorithm continues at the step 2220.

During this step (step 2220), it is verified whether there remain other predicates to process.

If this is the case, the algorithm continues at the step 2230 consisting of selecting the following predicate, then at step 2205 already described.

In the opposite case, the algorithm continues at the step 2240 during which it is verified whether all the predicates of a solution node ns have been validated, that is to say whether for each of the predicates, the verification, carried out in particular according to the algorithm of FIG. 23 described below, has yielded a positive result.

Furthermore, at this step 2240, it is also verified that the solution node ns corresponds to the first row of the table. This verification makes it possible to yield the results generated in the proper order.

If the verification is the negative, the algorithm is made to terminate at step 2290.

On the contrary, if the verification is positive, the algorithm continues at the step 2245 consisting of deleting the solution node ns from the table.

Next, at the following step (step 2250), the result corresponding to the solution node ns is generated.

The algorithm continues at the step 2255 consisting of invoking the algorithm of FIG. 22 recursively to verify the solution node situated in the new first row of the table, if the latter exists.

Next, the algorithm is made to terminate at step 2290.

Returning to step 2215, if the verification of the predicate p is negative, the algorithm continues at the step 2270 with the deletion of the solution node ns, and, in particular, by deleting the corresponding row of the table.

Next, at step 2275, the algorithm of FIG. 22 is recursively invoked in order to verify the solution node situated in the first row of the table, if the latter exists.

According to one embodiment, with a view to optimizing the algorithm, the verification of the step 2275 is only carried out if the deleted solution node is situated in the first row of the table.

Step 2275 is followed by step 2290, consisting of ending the algorithm.

At step 2290, the results generated, either at step 2250, or at the time of a recursive invocation of the algorithm, are yielded in the order in which they were generated.

According to a particular embodiment, when the search context corresponding to the solution nodes stored in the table is terminated, that is to say when all the events describing the content of that search context have been received, no further solution node can be added to the table. In this case, this information is stored and the algorithm is invoked with the first solution node contained in the table as parameter.

A description is now given, with reference to FIG. 23, of the verification of a predicate p for a solution node ns.

The algorithm begins at step 2300 with the determination of the type of the predicate p.

Step 2300 is followed by step 2310, during which it is tested whether the predicate p is a location path.

If that is the case, the algorithm continues at the step 2315 during which the value stored in the table is verified for that predicate p and that solution node ns. If the value is “not-found”, the verification is indeterminate. If the value is “found”, the verification is positive. Lastly, if the value is “cannot be found”, the verification is negative. The algorithm next continues at step 2340 described below.

In the opposite case, that is to say if the predicate p is not a location path, the algorithm continues at the step 2320 consisting of testing whether the predicate is an expression then requiring the generation of a solution node.

If that is the case, the algorithm continues at the verification step (step 2325) during which the solution node is evaluated. The result of the verification is thus the result of the evaluation. The algorithm next continues at step 2340 described below.

In the opposite case, that is to say if the predicate is not an expression, the algorithm continues at the step 2330 during which the predicate is evaluated directly, in particular, on the basis of the information available in the table, i.e., for example, the counting of the number of solutions, the end of the search context for the solution nodes. The algorithm then continues at step 2340.

Step 2340 consists of testing the verification state of the predicate.

If the verification is indeterminate, the algorithm continues at the step 2350 consisting of yielding the value “indeterminate”.

If the verification is negative, the algorithm continues at the step 2360 consisting of yielding the value “false”.

Lastly, if the verification is positive, the algorithm continues at the step 2370 consisting of updating the counting table. For this, the algorithm determines the position of the predicate in the list of the predicates of the location step.

For example, in the XPath expression 1310 of FIG. 13, the predicate “[c]” is in first position.

The cell to modify to update the counting table is that corresponding to the position of the predicate plus 1. This cell is modified by incrementing its value by 1.

The algorithm then terminates at step 2375 consisting of yielding the value “true”.

In order to implement the method of evaluating at least one predicate of an expression relating to elements of a structured document, a device for evaluating at least one predicate of an expression relating to elements of a structured document comprises in particular means for associating at least one evaluation state with at least one predicate of said plurality of predicates, means for obtaining an event describing a part of the structured document, means for updating said at least one evaluation state on the basis of the obtained event, and means for evaluating the plurality of predicates depending on said at least one updated evaluation state.

This device for evaluating an expression relating to elements of a structured document can be incorporated in a computer 1200 as illustrated in FIG. 12.

In particular, the various means identified above can be incorporated in the read only memory 1205, or “ROM” adapted to store a program for evaluating an expression relating to elements of a structured document in accordance with the invention.

The random access memory 1210, or “RAM” is adapted to store in registers the values modified during the execution of the program for evaluating an expression relating to elements of a structured document.

The fixed or removable storage means may comprise the code of the method of evaluating an expression relating to elements of a structured document in accordance with the invention.

They are also adapted to store an electronic document containing hierarchized data as defined by the present invention.

As a variant, the program enabling the device for evaluating at least one predicate of an expression to implement the invention can be stored in the read only memory 1205.

As a second variant, the program can be received and stored as described previously via the communication network 1235.

Naturally, numerous modifications can be made to the example embodiments described above without departing from the scope of the invention.

1. Method of evaluating an expression on items of a structured document, an expression comprising a set of elementary sub-expressions, that comprises the following prior steps:
generating, from the expression, a set of target nodes corresponding to items to be sought in the structured document;
generating a logical representation of the expression, a logical representation comprising a set of nodes, representing the elementary sub-expressions of the expression, linked according to relationships between these elementary sub-expressions;
and a step of evaluating the expression on items of the structured document from all the target nodes generated and the logical representation generated.

2. A method according to claim 1, wherein the step of generating a set of target nodes also comprises the generation of a representation of the relationships between the target nodes.

3. A method according to claim 1, wherein the step of evaluating the expression comprises:
a step of filtering the items of the document from all the target nodes; and
a step of evaluating the filtered items from the logical representation.

4. A method according to claim 3, wherein the step of filtering the items of the document from all the target nodes comprises a step of identifying the items of the document corresponding to target nodes from all the target nodes.

5. A method according to claim 3, wherein the step of evaluating the filtered items comprises a step of creating a solution node associated with a node of the logical representation, this solution node representing an evaluation result for the node of the logical representation.

6. A method according to claim 5, wherein the step of creating a solution node associated with a node of the logical representation comprises a step of associating a filtered item with this solution node.

7. A method according to claim 6, wherein the step of evaluating the filtered items also comprises a step of creating a relationship between a first solution node associated with a first node of the logical representation and at least one second solution node associated with a second node of the logical representation in accordance with the relationship between the first node of the logical representation and the second node of the logical representation.

8. A method according to claim 7, wherein the step of evaluating the expression also comprises a step of verifying the completeness of a solution comprising the following sub-steps:
verifying the existence for each node of the logical representation of at least one associated solution node;
selecting for each node of the logical representation an associated solution node, all the solution nodes selected forming a solution;
for each relationship between two nodes of the logical representation, checking that a similar relationship exists between the associated solution nodes selected.

9. A method according to claim 8, wherein the step of evaluating the expression comprises, if the step of verifying the completeness of a solution is positive, a step of generating a result from the solution.

10. A method according to claim 3, wherein a search context is associated with a filtered item corresponding to a node of the logical representation and to a node of the logical representation that is a descendant of the node corresponding to the filtered item.

11. A method according to claim 10, wherein a search context comprises information identifying part of the document in which an item corresponding to the descendant node is sought.

12. A method according to claim 1, that comprises a step of transmitting a result as from the end of the evaluation of the expression.

13. A method according to claim 5, that comprises a step of eliminating a solution node, the solution node being eliminated according to a criterion of validity of the solution node.

14. A method according to claim 13, wherein the criterion of validity of a solution node depends on the relationships existing between this solution node and other solution nodes and search contexts associated with the node of the logical representation associated with this solution node.

15. A method according to claim 1, for further evaluating a plurality of predicates associated with a sub-expression of an expression relating to items of a structured document, that comprises:
a step of associating at least one evaluation state with at least one predicate of said plurality of predicates,
a step of obtaining an event describing a part of the structured document,
a step of updating said at least one evaluation state on the basis of the obtained event, and
a step of evaluating the plurality of predicates on the basis of said at least one updated evaluation state.

16. A method according to claim 15, that comprises:
a step of creating at least one solution node representing at least one event describing a part of the structured document, and
a step of associating said at least one solution node with said sub-expression.

17. A method according to claim 16, wherein the step of associating at least one evaluation state associates an evaluation state with at least one pair comprising a predicate and a solution node.

18. A method according to claim 17, that comprises a step of deleting the solution node associated with the evaluation state if that evaluation state indicates that the predicate associated with that evaluation state is not verified and can no longer be verified.

19. A method according to claim 16, wherein a predicate of the plurality of predicates being dependent on the position of the solution node, the position of the solution node is calculated as the position of the preceding solution node incremented by the value 1 if the position of the preceding solution node is known and if the predicates preceding said evaluated predicate are verified for the solution node.

20. A method according to claim 15, that comprises a step of updating at least one other evaluation state on the basis of said at least one updated evaluation state.

21. A method according to claim 15, wherein said at least one evaluation state is stored in a table.

22. A method according to claim 15, that comprises a counting table comprising, for at least one predicate, the number of events verifying said at least one predicate.

23. A method according to claim 15, that comprises a step of transmitting a result if all the predicates are verified at the step of evaluating the plurality of predicates.

24. A method according to claim 15, wherein a predicate of the plurality of predicates being a location path, the evaluation state takes:
a value indicating that the evaluation of the predicate is positive if the event obtained enables the updating step to complete the location path,
a value indicating that the evaluation of the predicate is negative if the event obtained enables the updating step to determine that a location path cannot be found, and
a value indicating that the evaluation of the predicate is indeterminate in the other cases.

25. A method according to claim 15, wherein a predicate of the plurality of predicates being an expression, the evaluation state takes:
a value corresponding to the result of the evaluation of the expression if the event obtained enables the updating step to complete the evaluation of the expression, and
a value indicating that the evaluation of the predicate is indeterminate in the other cases.

26. Device for evaluating an expression on items of a structured document, an expression comprising a set of elementary sub-expressions, that comprises:
means of generating, from the expression, a set of target nodes corresponding to items to be sought in the structured document;
means of generating a logical representation of the expression, a logical representation comprising a set of nodes, representing the elementary sub-expressions of the expression, linked according to relationships between these elementary sub-expressions; and
means of evaluating the expression on items of the structured document from all the target nodes generated and the logical representation generated.

27. A device according to claim 26 for further evaluating a plurality of predicates associated with a sub-expression of an expression relating to items of a structured document, that comprises:
means for associating at least one evaluation state with at least one predicate of said plurality of predicates,
means for obtaining an event describing a part of the structured document,
means for updating said at least one evaluation state on the basis of the obtained event, and
means for evaluating the plurality of predicates on the basis of said at least one updated evaluation state.

28. Computer program product able to be loaded into a programmable apparatus, that contains sequences of instructions for implementing a method according to claim 1, when this program is loaded into and executed by the programmable apparatus.

29. Information storage means, able to be read by a computer or a microprocessor storing instructions of a computer program, that allows the implementation of a method of evaluating an expression on items of a structured document according to claim 1.
